(19) United States
(12) Patent Application Publication
(10) Pub. No.: US 2008/0241330 A1
(43) Pub. Date: Oct. 2, 2008

(54) Ready-To-Eat Gelatin Noodle and Process for Producing the Same

(75) Inventors: Yoshiyuki Imanishi, Osaka (JP); Toshiaki Sonoda, Osaka (JP); Kazuo Nagao, Osaka (JP); Masafumi Nakano, Osaka (JP)

Correspondence Address: QUINN EMANUEL;KODA & ANDROLIA, 865 S. FIGUEROA STREET, 10TH FLOOR, LOS ANGELES, CA, 90017, US

(73) Assignee: Acecook Co., Ltd

(21) Appl. No.: 10/572,049

(22) PCT Filed: May 31, 2005
(86) PCT No.: PCT/JP2005/009961

§ 371 Date: Mar. 15, 2006

(30) Foreign Application Priority Data
Nov. 19, 2004 (JP) 2004-335719

(51) Int. Cl. A23L 1/0522

(52) U.S. Cl. 426/549

(57) ABSTRACT

The present inventions provides a process for producing ready-to-eat gelatin noodle which can inhibit the dissolution during the boiling step as well as the extension and the swell-up after cooking to result in producing ready-to-eat gelatin noodle which makes us feel suitable elasticity and comfortable chewing on eating it and is delicious. This ready-to-eat gelatin noodle is produced from a starting material of mixed starch which consists of potato starch and green-gram starch mixed with each other. A food base material such as carrot powder is kneaded into the mixed starch and 2 to 5 wt % of curdlan is added to the mixed starch containing the food base material. This mixed starch with the food base material contained is kneaded with water and is extruded into boiling water through a die to form lines of noodle. These lines of noodle are boiled with boiling water and then are washed with water to cool them. The thus cooled lines of noodle are frozen in a refrigerator and de-frozen. Thereafter, they are cut to a predetermined length and weighed and then dried with hot air.

### TECHNICAL FIELD

The present invention relates to ready-to-eat gelatin noodle and a process for producing the same.

### BACKGROUND ART

Proposed as a process for producing ready-to-eat gelatin noodle is a process which comprises the steps of kneading green-gram starch with water; extrusion-molding the thus kneaded green-gram starch through a number of nozzles to lines of green-gram starch; boiling them; washing them with water; freezing them to form rough mass and de-freezing it; and drying it (for example, see Patent Literature 1).

Patent Literature: 1 Patent Public Disclosure No. 2001-17105

### DISCLOSURE OF THE INVENTION

### The Problem the Invention Attempts to Solve

However, the above-mentioned ready-to-eat gelatin noodle has problems that the green-gram starch is readily dissolved out during the boiling step and it takes time to return it with boiling water to the original state. Further, since it is produced from starch only, it has no flavor nor odor to make us feel it has plain taste.

The present invention has been created so as to solve the above problems. It has an object to provide ready-to-eat gelatin noodle and a process for producing the same which comprises kneading vegetable powder, sea-leaf powder, soybean milk powder and the like food base material of non-stickiness into the mixed starch consisting of potato starch and green-gram starch, a starting material of ready-to-eat gelatin noodle, and adding curdlan thereto so as to inhibit the dissolution of starch during the boiling step as well as the extension and swell-up caused by boiling water after it has been cooked, thereby obtaining ready-to-eat gelatin noodle which presents proper elastic feeling upon eating it and is delicious.

### Means for Solving the Problem

The ready-to-eat gelatin noodle of the present invention is characterized by kneading the food base material of non-stickiness into the mixed starch consisting of potato starch and green-gram starch, a starting material for producing the ready-to-eat gelatin noodle, and adding 2 to 5 wt % of curdlan to the mixed starch containing the food base material.

The process for producing ready-to-eat gelatin noodle of the present invention is characterized by kneading the food base material of non-stickiness into the mixed starch consisting of potato starch and green-gram starch and adding 2 to 5 wt % of curdlan to the thus produced mixed starch during the process of producing the ready-to-eat gelatin noodle from the starting material of the mixed starch consisting of potato starch and green-gram starch.

### EFFECT OF THE INVENTION

It is possible to supplement the disadvantage of taking time so as to return the green-gram starch to its original state that the green-gram starch has, with potato starch while keeping the elasticity and smoothness of the green-gram starch, by mixing the green-gram starch with potato starch.

While mixing the green-gram starch with the potato starch can make the green-gram starch return to its original state by boiling water more quickly so as to meet the requirement for ready-to-eat, it readily causes the extension and swell-up with boiling water after cooking. However, if the curdlan is added in the ratio of 2 to 5 wt %, it swells and acts to increase the stickiness, thereby inhibiting the gelatin noodle from extending and swelling up with the boiling water after it has been cooked to result in producing ready-to-eat gelatin noodle which makes us enjoy the smooth elasticity and comfortable chewing.

Particularly, when a food base material of non-stickiness is kneaded into the mixed starch of green-gram starch and potato starch, it is possible to attain ready-to-eat gelatin noodle to which the flavor, deliciousness and odor that the food base material has are added.

Besides, in the event that 2 to 5 wt % of curdlan is added to the mixed starch together with a food base material of non-stickiness, the curdlan swells and acts to increase the stickiness to reduce the dissolution of the starch and the food base material during the boiling step. Therefore, when the formed lines of gelatin noodle (hereafter referred to as “lines of noodle”) are hung on a straight bar upon freezing, the lines of noodle are not attached together nor cut, but they are readily loosened and also are loosened well after de-freezing them, which leads to becoming excellent in the ability of processing the gelatin noodle and the workability.

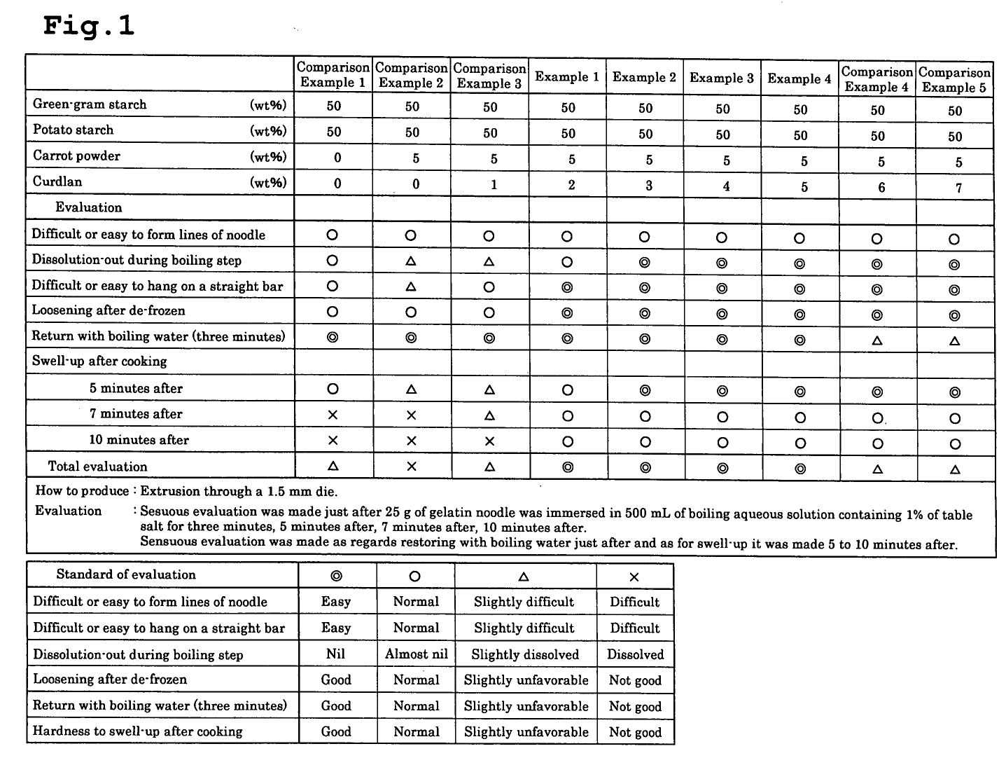

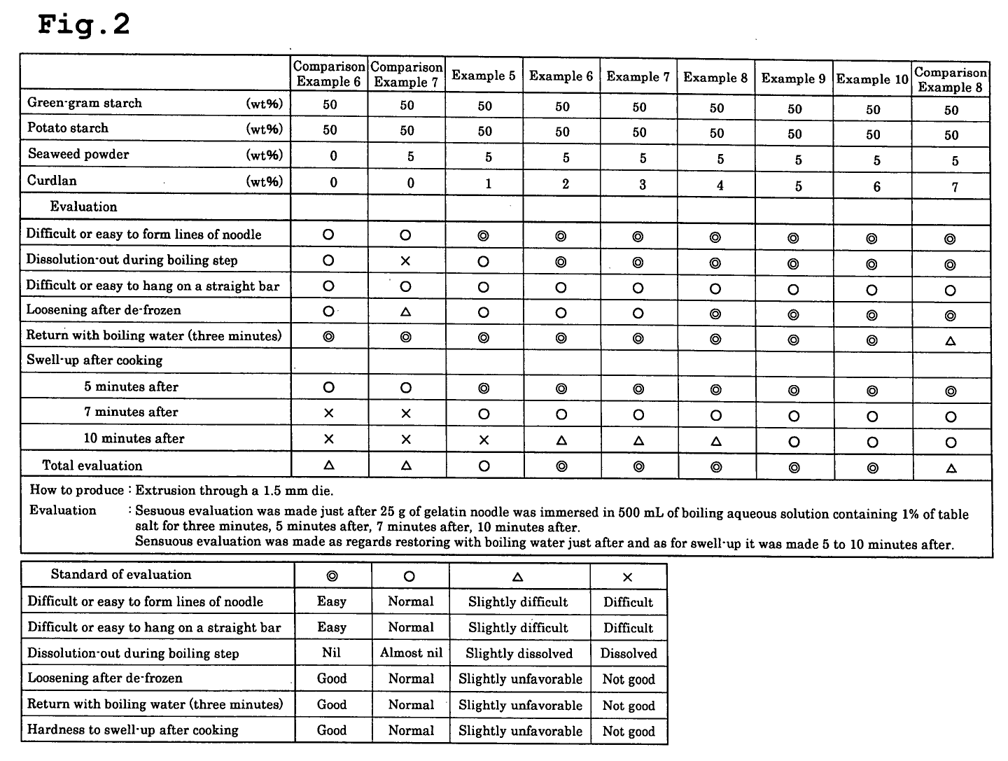

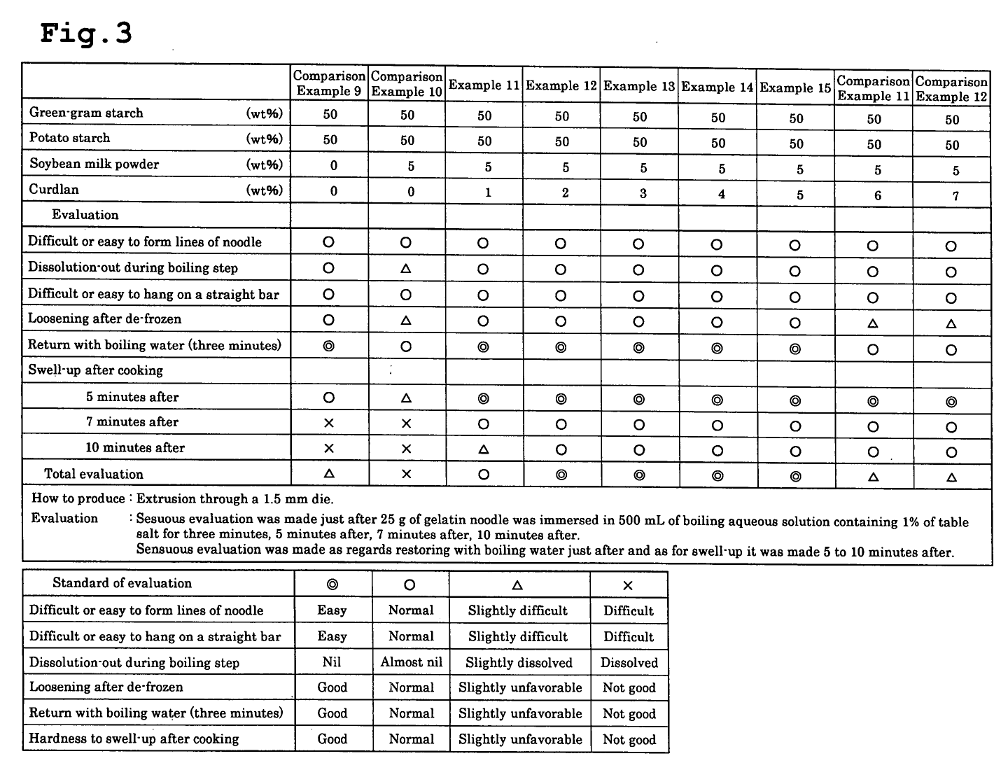

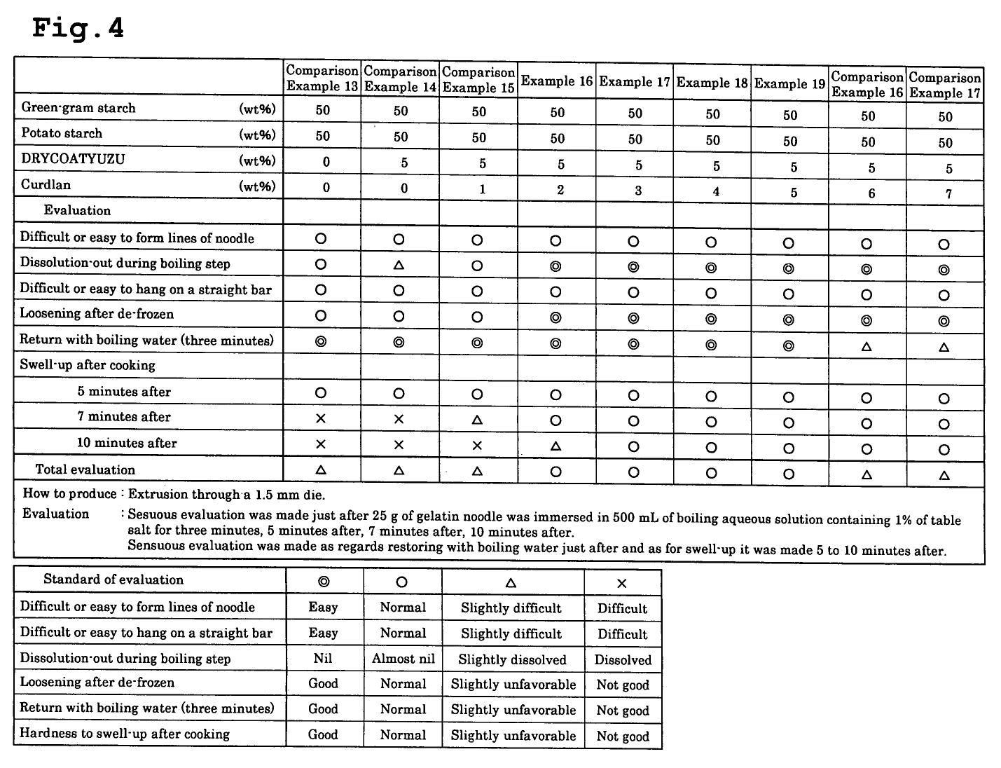

### BRIEF DESCRIPTION OF THE DRAWINGS

[FIG. 1] is a Table Figure showing the evaluation results such as the extension and the swell-up caused by boiling water, of Examples 1 to 4 as well as those of Comparison Examples 1 to 5.

[FIG. 2] is a Table Figure showing the evaluation results such as the extension and the swell-up caused by boiling water, of Examples 5 to 10 as well as those of Comparison Examples 6 to 8.

[FIG. 3] is a Table Figure showing the evaluation results such as the extension and the swell-up caused by boiling water, of Examples 11 to 15 as well as those of Comparison Examples 9 to 12.

[FIG. 4] is a Table Figure showing the evaluation results such as the extension and the swell-up caused by boiling water, of Examples 16 to 19 as well as those of Comparison Examples 13 to 17.

### MOST PREFERRED EMBODIMENT OF THE INVENTION FOR PUTTING IT INTO PRACTICE

During the process of producing ready-to-eat gelatin noodle according to the present invention, curdlan is added to the mixture of the green-gram starch and the potato starch, with a food base material of non-stickiness. At this time, the mixed starch is mixed with water by a mixer and the thus kneaded mixed starch (material) is extruded into boiling water through a die to form lines of noodle. The thus formed lines of noodle are boiled with boiling water and are washed with water to cool them. The cooled lines of noodle are hung on a straight bar and frozen in a refrigerator. Subsequently, they are de-frozen, cut to a predetermined length, weighted and then dried with hot air to complete the production of ready-to-eat gelatin noodle.

Even if the ready-to-eat gelatin noodle is returned well to its original state through pouring boiling water, only by mixing the potato starch with the green-gram starch, it extends and swells up a few minutes after cooking. The gelatin noodle packed in a cup is eaten up within 7 minutes in average, but it starts swelling up 7 minutes after cooking. However, it is possible to solve the problem that the gelatin noodle extends and swells up, by adding curdlan. More specifically, when 2 to 5 wt % of curdlan is added to the mixed starch of green-gram starch and potato starch, the curdlan acts to increase the stickiness, thereby preventing the gelatin noodle from extending and swelling up after cooking to result in the possibility of attaining ready-to-eat gelatin noodle which makes us enjoy its smoothness and comfortable chewing.

In the case of adding the curdlan, if the amount is less than 2 wt %, the gelatin noodle extends and swells up 7 minutes after cooking. And when the amount is more than 5 wt %, the noodle becomes too hard to return with boiling water to its original state (just 3 minutes after) or it takes more than 5 minutes. Therefore, those amounts are not suitable for the ready-to-eat gelatin noodle.

Examples of the food base material of non-stickiness are powder of vegetables such as carrot and mushroom, powder of sea leaf such as seaweed, soybean milk powder, ‘yuzu’ (a kind of citrus fruit) powder and the like. The addition of these food base materials makes it possible to obtain ready-to-eat gelatin noodle added with the flavor, deliciousness and odor that the food base materials have.

If these food base materials are added together with the curdlan, they are inhibited from being dissolved out during the boiling step, thereby enabling their flavor, deliciousness and odor to appear when eating the gelatin noodle.

In order to more reduce the dissolution-out of the food base materials kneaded into the mixed starch, it is effective to deaerate them in vacuum. As for the way to deaerate in vacuum, it may be carried out from the state of the starch by a vacuum mixer. Or the dough kneaded up by another mixer may be deaerated by the vacuum mixer. Alternatively, the deaeration may be effected while extruding through an extruder. Such deaeration can offer the effects of further reducing the dissolution-out of the food base materials, improving the loosening of the lines of noodle and delaying the swell-up after the produced gelatin noodle has been returned with boiling water to its original state.

### EXAMPLES

### Example 1

50 wt % of potato starch was mixed with 50 wt % of green-gram starch to form a mixture, to which 2 wt % of curdlan and 5 wt % of carrot powder were added. At this time, preliminarily, part (for example 10 wt part) of the mixed starch was heated to make it paste while mixing 100 wt part of water to form a carrier paste. This carrier paste was added to the remaining part of the mixed starch and kneaded by a mixer to form a material. Next, this material was extruded into boiling water through a die of 1.5 mm diameter by an extruder and was molded into lines. Next, the molded lines of noodle were boiled in hot water of 98 degrees C. to 100 degrees C. for about 1 minute and then were taken out to wash and cool them with water. Subsequently, the cooled lines of noodle were hung on a straight bar and frozen in a refrigerator at a temperature of −20 degrees C. overnight. On the next day, they were de-frozen with water and cut to about 15 cm, and weighted. Then they were thrown into a metal framework and dried for 25 minutes with hot air of 80 degrees C. Thus dried ready-to-eat gelatin noodle containing about 10% of moisture was obtained.

Used for the curdlan was the “CURDLAN S” of trade name, made by Takeda Kirin Foods Kabushiki Kaisha. And employed for the carrot powder was the “CARROT POWDER K” of trade name, made by Fine Foods Kabushiki Kaisha.

### Examples 2 to 4

Examples 2 to 4 were carried out in the same manner as Example 1 except that Examples 2, 3 and 4 added the curdlan in the respective ratios of 3 wt %, 4 wt % and 5 wt %.

### Comparison Examples 1 to 3

Comparison Example 1 was conducted in the same manner as Example 1 except that curdlan and carrot powder were not added. Comparison Example 2 added 5 wt % of carrot powder but did not add the curdlan. Comparison Example 3 was conducted in the same manner as Example 1 except that 1 wt % of curdlan was added.

### Comparison Examples 4 and 5

Comparison Examples 4 and 5 were carried out in the same manner as Example 1 except that Examples 4 and 5 added the curdlan in the respective ratios of 6 wt % and 7 wt %.

Evaluation results of Examples 1 to 4 are shown in the Table of FIG. 1 as well as those of Comparison Examples 1 to 5. The following fact can be seen from this Table Figure.

In the case where no curdlan is added to the mixture of potato starch and green-gram starch as in Comparison Examples 1 and 2 or even if the curdlan was added, the amount is less than 2 wt % as in Comparison Example 3, the gelatin noodle extends and swells up by boiling water 5 to 7 minutes after cooking. Nevertheless, in the event that the curdlan is added in the amount of more than 5 wt % as in Comparison Examples 4 and 5, the gelatin noodle is too hard to return with boiling water to its original state (just 3 minutes after) and it takes more than 5 minutes to return the gelatin noodle with boiling water to its original state. Thus it is not suitable for the ready-to-eat gelatin noodle. Further, when the curdlan is not added or even if it is added, the amount is less than 2 wt %, it could be seen during the boiling step that the carrot powder was dissolved out. This results in losing the deliciousness of the carrot and fading the color of carrot.

If 2 to 5 wt % of curdlan is added with the carrot powder as in Examples 1 to 4, the gelatin noodle is well returned with boiling water to its original state (good restoring ability by boiling water). It was possible to obtain the gelatin noodle which did not make us feel the extension and the swell-up so much even 5 to 7 minutes after cooking. Further, during the boiling step, the carrot power was not dissolved out to result in the possibility of keeping the deliciousness of carrot and applying the color of carrot.

### Example 5

50 wt % of potato starch was mixed with 50 wt % of green-gram starch to form a mixture, to which 1 wt % of curdlan and 5 wt % of seaweed powder were added. At this time, preliminarily, part (for example 10 wt part) of the mixed starch was heated to make it paste while mixing 100 wt part of water to form a carrier paste. This carrier paste was added to the remaining part of the mixed starch and kneaded by a mixer to form a material. Next, this material was extruded into boiling water through a die of 1.5 mm diameter by an extruder and was molded into lines. Next, the molded lines of noodle were boiled in hot water of 98 degrees C. to 100 degrees C. for about 1 minute and then were taken out to wash and cool them with water. Subsequently, the cooled lines of noodle were hung on a straight bar and frozen in a refrigerator at a temperature of −20 degrees C. overnight. On the next day, they were de-frozen with water and cut to about 15 cm, and weighted. Then they were thrown into a metal framework and dried for 25 minutes with hot air of 80 degrees C. Thus dried ready-to-eat gelatin noodle containing about 10% of moisture was obtained.

Used for the curdlan was the “CURDLAN S” of trade name, made by Takeda Kirin Foods Kabushiki Kaisha. And employed for the seaweed powder was the “SEAWEED POWDER No. 2253” of trade name, made by Fine Foods Kabushiki Kaisha.

### Examples 6 to 10

Examples 6 to 10 were carried out in the same manner as Example 5 except that Examples 6, 7, 8, 9 and 10 added the curdlan in the respective ratios of 2 wt %, 3 wt %, 4 wt %, 5 wt % and 6 wt %.

### Comparison Examples 6 and 7

Comparison Example 6 was conducted in the same manner as Example 5 except that curdlan and seaweed powder were not added. Comparison Example 7 was conducted in the same manner as Example 5 except that 5 wt % of seaweed powder was added, but curdlan was not added.

### Comparison Example 8

Comparison Example 8 was carried out in the same manner as Example 5 except that it added 7 wt % of curdlan.

Evaluation results of Examples 5 to 10 are shown in the Table of FIG. 2 as well as those of Comparison Examples 6 and 7. The following fact can be seen from this Table Figure.

In the case where no curdlan is added to the mixture of potato starch and green-gram starch as in Comparison Examples 6 and 7, the gelatin noodle extends and swells up with boiling water 7 minutes after cooking. Nevertheless, in the event that the curdlan is added in the amount of more than 6 wt % as in Comparison Example 8, the gelatin noodle is so hard that it returns with boiling water to its original state (just 3 minutes after) slightly unfavorably and it takes more than 5 minutes to return the gelatin noodle with boiling water to its original state. Thus it is not suitable for the ready-to-eat gelatin noodle. Further, when the curdlan is not added, it could be seen during the boiling step that the seaweed powder was dissolved out. This results in losing the flavor and deliciousness of seaweed.

If 1 to 6 wt %, preferably 2 to 6 wt % of curdlan is added with the seaweed powder as in Examples 5 to 10, the gelatin noodle is well returned with boiling water to its original state (good restoring ability by boiling water). It was possible to obtain the gelatin noodle which did not make us feel the extension and the swell-up so much even 5 to 7 minutes after cooking. Further, during the boiling step, the seaweed powder was not dissolved out to result in the possibility of keeping the flavor and deliciousness of seaweed.

### Example 11

50 wt % of potato starch was mixed with 50 wt % of green-gram starch to form a mixture, to which 1 wt % of curdlan and 5 wt % of soybean milk powder were added. At this time, preliminarily, part (for example 10 wt part) of the mixed starch was heated to make it paste while mixing 100 wt part of water to form a carrier paste. This carrier paste was added to the remaining part of the mixed starch and kneaded by a mixer to form a material. Next, this material was extruded into boiling water through a die of 1.5 mm diameter by an extruder and was molded into lines. Next, the molded lines of noodle were boiled in hot water of 98 degrees C. to 100 degrees C. for about 1 minute and then were taken out to wash and cool them with water. Subsequently, the cooled lines of noodle were hung on a straight bar and frozen in a refrigerator at a temperature of −20 degrees C. overnight. On the next day, they were de-frozen with water and cut to about 15 cm, and weighted. Then they were thrown into a metal framework and dried for 25 minutes with hot air of 80 degrees C. Thus dried ready-to-eat gelatin noodle containing about 10% of moisture was obtained.

Used for the curdlan was the “CURDLAN S” of trade name, made by Takeda Kirin Foods Kabushiki Kaisha. And employed for the soybean milk powder was the “SOYBEAN MILK POWDER M-6653” of trade name, made by Fine Foods Kabushiki Kaisha.

### Examples 12 to 15

Examples 12 to 15 were carried out in the same manner as Example 11 except that Examples 12, 13, 14, and 15 added the curdlan in the respective ratios of 2 wt %, 3 wt %, 4 wt % and 5 wt %.

### Comparison Examples 9 and 10

Comparison Example 9 was conducted in the same manner as Example 11 except that curdlan and soybean milk powder were not added. Comparison Example 10 was conducted in the same manner as Example 11 except that 5 wt % of soybean milk powder was added, but curdlan was not added.

### Comparison Examples 11 and 12

Comparison Examples 11 and 12 were carried out in the same manner as Example 11 except that Comparison Examples 11 and 12 added curdlan in the respective ratios of 6 wt % and 7 wt %.

Evaluation results of Examples 11 to 15 are shown in the Table of FIG. 3 as well as those of Comparison Examples 9 to 12. The following fact can be seen from this Table Figure.

In the case where no curdlan is added to the mixture of potato starch and green-gram starch as in Comparison Examples 9 and 10, the gelatin noodle extends and swells up with boiling water 5 to 7 minutes after cooking. Nevertheless, in the event that the curdlan is added in the amount of more than 5 wt % as in Comparison Examples 11 and 12, the gelatin noodle is slightly unfavorably loosened after de-freezing. Further, when the curdlan is not added, it could be seen during the boiling step that the soybean milk powder was slightly dissolved out. This results in readily losing the deliciousness of soybean milk powder.

If 1 to 5 wt %, preferably 2 to 5 wt % of curdlan is added with the soybean milk powder as in Examples 11 to 15, the gelatin noodle is well returned with boiling water to its original state (good restoring ability by boiling water). It was possible to obtain the gelatin noodle which did not make us feel the extension and the swell-up so much even 5 to 7 minutes after cooking. Further, during the boiling step, the soybean milk powder was not dissolved out to result in the possibility of keeping the deliciousness of soybean milk powder.

### Example 16

50 wt % of potato starch was mixed with 50 wt % of green-gram starch to form a mixture, to which 2 wt % of curdlan and 5 wt % of “DRYCOATYUZU” (Trade Name of Fine Foods Kabushiki Kaisha) were added. At this time, preliminarily, part (for example 10 wt part) of the mixed starch was heated to make it paste while mixing 100 wt part of water to form a carrier paste. This carrier paste was added to the remaining part of the mixed starch and kneaded by a mixer to form a material. Next, this material was extruded into boiling water through a die of 1.5 mm diameter by an extruder and was molded into lines. Next, the molded lines of noodle were boiled in hot water of 98 degrees C. to 100 degrees C. for about 1 minute and then were taken out to wash and cool them with water. Subsequently, the cooled lines of noodle were hung on a straight bar and frozen in a refrigerator at a temperature of −20 degrees C. overnight. On the next day, they were de-frozen with water and cut to about 15 cm, and weighted. Then they were thrown into a metal framework and dried for 25 minutes with hot air of 80 degrees C. Thus dried ready-to-eat gelatin noodle containing about 10% of moisture was obtained.

Used for the curdlan was the “CURDLAN S” of trade name, made by Takeda Kirin Foods Kabushiki Kaisha.

### Examples 17 to 19

Examples 17 to 19 were carried out in the same manner as Example 16 except that Examples 17, 18 and 19 added the curdlan in the respective ratios of 3 wt %, 4 wt % and 5 wt %.

### Comparison Examples 13 to 15

Comparison Example 13 was conducted in the same manner as Example 16 except that curdlan and “DRYCOATYUZU” were not added. Comparison Example 14 was conducted in the same manner as Example 16 except that 5 wt % of “DRYCOATYUZU” was added, but curdlan was not added. Comparison Example 15 was conducted in the same manner as Example 16 except that 1 wt % of curdlan was added.

### Comparison Examples 16 and 17

Comparison Examples 16 and 17 were carried out in the same manner as Example 16 except that Comparison Examples 16 and 17 added curdlan in the respective ratios of 6 wt % and 7 wt %.

Evaluation results of Examples 16 to 19 are shown in the Table of FIG. 4 as well as those of Comparison Examples 13 to 17. The following fact can be seen from this Table Figure.

In the case where no curdlan is added to the mixture of potato starch and green-gram starch as in Comparison Examples 13 and 14 or even if added, it is added in such a small amount of less than 2 wt % as in Comparison Example 15, the gelatin noodle extends and swells up with boiling water 7 minutes after cooking. Nevertheless, in the event that the curdlan is added in the amount of more than 5 wt % as in Comparison Examples 16 and 17, the gelatin noodle is so hard that it returns with boiling water to its original state (just 3 minutes after) slightly unfavorably and it takes more than 5 minutes to return the gelatin noodle by boiling water to its original state. Thus it is not suitable for the ready-to-eat gelatin noodle. Further, when the curdlan is not added, it could be seen during the boiling step that the “DRYCOATYUZU” was dissolved out. This results in losing the citrus flavor and odor of “DRYCOATYUZU”.

If 2 to 5 wt % of curdlan is added with the “DRYCOATYUZU” as in Examples 16 and 19, the gelatin noodle is well returned with boiling water to its original state (good restoring ability by boiling water). It was possible to obtain the gelatin noodle which did not make us feel the extension and the swell-up so much even 5 to 7 minutes after cooking. Further, during the boiling step, the “DRYCOATYUZU” was not dissolved out to result in the possibility of keeping the flavor and odor of yuzu (a kind of citrus fruit).

1. Ready-to-eat gelatin noodle prepared from a starting material of mixed starch which consists of potato starch and green-gram starch mixed with each other, wherein a food base material of non-stickiness is kneaded into the mixed starch, to which 2 to 5 wt % of curdlan is added.

2. A process for producing ready-to-eat gelatin noodle from a starting material of mixed starch which consists of potato starch and green-gram starch mixed with each other, comprising the steps of:
kneading a food base material of non-stickiness into the mixed starch; and
adding 2 to 5 wt % of curdlan to the thus obtained mixed starch containing the food base material.
